(19) United States
(12) Patent Application Publication
(10) Pub. No.: US 2019/0297919 A1
(43) Pub. Date: Oct. 3, 2019

(54) METHOD OF MAKING TOMATO WATER

(71) Applicant: Marie Krane, Chicago, IL (US)

(72) Inventor: Marie Krane, Chicago, IL (US)

(21) Appl. No.: 16/446,387

(22) Filed: Jun. 19, 2019

Related U.S. Application Data
(63) Continuation-in-part of application No. 15/725,832, filed on Oct. 5, 2017.

(51) Int. Cl. A23L 2/12; A23L 2/04; A23L 19/00

(52) U.S. Cl. CPC A23L 2/12; A23L 2/04; A23V 2250/21; A23V 2002/00; A23L 19/09

(57) ABSTRACT

The present invention provides a method of making substantially solid-free and clear tomato water. The method includes the steps of: (1) Cutting, dicing, pressing, juicing or otherwise reducing whole tomatoes into pulp and liquid material; (2) Removing at least some of the pulp from the pulp and liquid material to form a filtered liquid material; (3) Freezing the filtered liquid material into a frozen solid material; (4) Maintaining the frozen solid material in its frozen state for at least 24 hours at a temperature at or below 20° F.; (5) Thawing the frozen pulp and liquid material at a temperature of approximately 40° F. to form a thawed material; (6) Allowing the thawed material to rest until the thawed material separates into a clear tomato water top layer and a particulate solid pulp an liquid bottom layer; and, (7) Drawing off the clear liquid tomato water top layer from the thawed material.

### REFERENCE TO PRIOR APPLICATION

This application is a Continuation-in-Part of U.S. utility application Ser. No. 15/725,832, filed on Oct. 5, 2017, which is incorporated in its entirety herein by reference and made a part hereof.

### BACKGROUND OF THE INVENTION

This invention relates to a method of making tomato water, and more particularly concerns a method of making a water-based beverage having the decided taste and bouquet of tomatoes yet having no objectionable color or discernible solid material anywhere in the water.

Pure bottled water is now an important product in grocery and food stores. Everyone knows pure water has no odor, no taste, and no color, and everyone has been taught that pure water is good for you.

But in the constant competition for grocery store shelf space and in restaurant beverage sales, market managers have learned that many consumers want something more than plain water. Many competing water-based beverages contain colorants, dissolved gases, and some homogenized beverages and juices contain fruit or vegetable particulates.

Tomatoes are well known to have a distinctive and pleasing aroma and ingredients which are helpful and pleasing to the consumer. Currently offered traditional tomato juices are opaque, relatively thick, and have a substantial but limited market appeal. There is relatively little market cross-over activity between water-based beverages and traditionally prepared tomato juice.

It is the general object of this invention to provide a tomato water which is clear yet colorful; which has the taste and aroma of highly ripe tomatoes; which is delicious but which contains no discernible solids; and which is preferably prepared from non-hybrid and commercially unattractive tomatoes.

A related object is to encourage the commercial growth of non-hybrid tomatoes and the commercial use of imperfect tomatoes.

Other objects and advantages of this invention will become apparent upon reading the following detailed description and upon reference to the claims.

### SUMMARY OF THE INVENTION

The present invention provides a method of making substantially solid-free and clear tomato water. The method includes the steps of: (1) Cutting, dicing, pressing, juicing or otherwise reducing whole tomatoes into pulp and liquid material; (2) Removing at least some of the pulp from the pulp and liquid material to form a filtered liquid material; (3) Freezing the filtered liquid material into a frozen solid material; (4) Maintaining the frozen solid material in its frozen state for at least 24 hours at a temperature at or below 20° F.; (5) Thawing the frozen pulp and liquid material at a temperature of approximately 40° F. to form a thawed material; (6) Allowing the thawed material to rest until the thawed material separates into a clear tomato water top layer and a particulate solid pulp an liquid bottom layer; and, (7) Drawing off the clear liquid tomato water top layer from the thawed material.

The present invention further provides a method of making substantially solid-free and clear tomato water, comprising the steps of: (1) Cutting, dicing, pressing, juicing or otherwise reducing whole heirloom and heritage tomatoes into a pulp and liquid material; (2) Thereafter removing at least some of the pulp from the pulp and liquid material to form a filtered liquid material; (3) Thereafter freezing the filtered liquid material into a frozen solid material; (4) Thereafter maintaining the frozen solid material in its frozen state for at least 24 hours at a temperature at or below 20° F.; (5) Thereafter thawing the frozen solid material to form a thawed material; (6) Thereafter allowing the thawed material to rest until the thawed material separates into a clear liquid tomato water top layer and a solid particulate bottom layer; and, (7) Thereafter drawing off the clear liquid tomato water top layer from the thawed material.

### DETAILED DESCRIPTION

In a first step of making this novel tomato water, a quantity of preferably non-hybrid tomatoes such as heirloom and heritage or other low-cost tomatoes is cut, diced, pressed, juiced or otherwise reduced to fine particles and liquid. These tomatoes can include Aunt Ruby German Green, Cherokee Purple, Kellogg's Breakfast, Green Zebra, Black Krim, Ukrainian Purple and Mareno. A cold-press juicer system or machine can be used to provide this reduction. The juicer or machine removes seeds and skin from the juice.

Thereafter the resulting juice is frozen until thoroughly solid. For example, the juice can be frozen at 0° F. for at least 24 hours.

Thereafter the material is thawed and melted in a refrigerator at approximately 40° F. until all the juice ice has completely melted.

During and after this thawing and melting, liquid/solid separation will occur over a period of time, for example, four hours.

The thawed material is then poured into a container and left in repose until the material separates into liquid at the top and solids at the bottom.

Thereafter, the liquid is strained from the solids, the liquid is poured off into containers, and the solids are discarded.

If desired, the liquid fraction can be heated to 170° Fahrenheit but not above 190° Fahrenheit and simmered five minutes but for up to fifteen minutes in order to prepare the water for enhanced shelf life stability.

The tomato water is then strained from the solids. The liquid is poured off into containers and the solids are discarded.

If desired, the tomato water product can be preserved with or without citric acid or some other appropriate material. Supplements such as Vitamin B, Green tea, Guarana Seed extract, ginger root extract, L-carnitine, choline, Vitamin B12, Vitamin B7, Vitamin B6, Vitamin B3, Vitamin C, garlic extract, or turmeric may be added.

Flavoring agents such as lime and ginger can be added as desired. The beverage can be carbonated, use a known hotfill and hold process to place the liquid in, for example, 16 ounce bottles.

Many modifications and variations of the present invention are possible in light of the above teachings. It is, therefore, to be understood within the scope of the appended claims the invention may be protected otherwise than as specifically described.

I claim:

1. A method of making substantially solid-free and clear tomato water, comprising the steps of:
Cutting, dicing, pressing, juicing or otherwise reducing whole tomatoes into pulp and liquid material;
Removing at least some of the pulp from the pulp and liquid material to form a filtered liquid material;
Freezing the filtered liquid material into a frozen solid material;
Maintaining the frozen solid material in its frozen state for at least 24 hours at a temperature at or below 20° F.;
Thawing the frozen pulp and liquid material at a temperature of approximately 40° F. to form a thawed material;
Allowing the thawed material to rest until the thawed material separates into a clear tomato water top layer and a particulate solid pulp an liquid bottom layer; and,
Drawing off the clear liquid tomato water top layer from the thawed material.

2. A method according to claim 1 wherein the whole tomatoes are heirloom tomatoes.

3. A method according to claim 1 wherein the whole tomatoes are non-hybrid tomatoes.

4. A method according to claim 1 including wherein the whole tomatoes are fresh tomatoes.

5. A method according to claim 1 wherein the step of allowing the material to rest is for a period of at least three hours.

6. A method according to claim 1 wherein the step of reducing whole tomatoes into pulp and liquid material comprises a cold-press juicer system.

7. A method of claim 6 wherein the step of reducing whole tomatoes into pulp and liquid material comprises removing seeds and skins from the pulp and liquid material.

8. A method of claim 1 further comprising a step of heating the clear liquid tomato water top layer to a temperature from 170° F. to 190° F.

9. A method of claim 8 wherein the heating step comprises heating for a period from five minutes to fifteen minutes.

10. A method of claim 1 further comprising the step of preserving the clear liquid tomato water top layer.

11. A method of claim 10 wherein the step of preserving comprises adding to the clear liquid tomato water top layer by adding an effective amount of a citric acid.

12. A method of claim 10 wherein the step of preserving comprises adding to the clear liquid tomato water top layer by adding an effective amount of an ingredient selected from the group consisting of Vitamin B, Green tea, Guarana Seed extract, ginger root extract, L-carnitine, choline, Vitamin B12, Vitamin B7, Vitamin B6, Vitamin B3, Vitamin C, garlic extract, and turmeric.

13. A method of making substantially solid-free and clear tomato water, comprising the steps of:
Cutting, dicing, pressing, juicing or otherwise reducing whole heirloom and heritage tomatoes into a pulp and liquid material;
Thereafter removing at least some of the pulp from the pulp and liquid material to form a filtered liquid material;
Thereafter freezing the filtered liquid material into a frozen solid material;
Thereafter maintaining the frozen solid material in its frozen state for at least 24 hours at a temperature at or below 20° F.;
Thereafter thawing the frozen solid material to form a thawed material;
Thereafter allowing the thawed material to rest until the thawed material separates into a clear liquid tomato water top layer and a solid particulate bottom layer; and,
Thereafter drawing off the clear liquid tomato water top layer from the thawed material.

14. A method according to claim 13 wherein the step of allowing the material to rest is for a period of at least three hours.

15. A method according to claim 13 wherein the step of reducing the whole heirloom and heritage tomatoes into a pulp and liquid material comprises a cold-press juicer system.

16. A method of claim 13 wherein the step of reducing whole tomatoes into pulp and liquid material comprises removing seeds and skins from the pulp and liquid material.

17. A method of claim 13 further comprising a step of heating the clear liquid tomato water top layer to a temperature from 170° F. to 190° F.

18. A method of claim 17 wherein the heating step comprises heating for a period from five minutes to fifteen minutes.

19. A method of claim 13 further comprising the step of preserving the clear liquid tomato water top layer.

20. A method of claim 10 wherein the step of preserving comprises adding to the clear liquid tomato water top layer an effective amount of an ingredient selected from the group consisting of citric acid, Vitamin B, Green tea, Guarana Seed extract, ginger root extract, L-carnitine, choline, Vitamin B12, Vitamin B7, Vitamin B6, Vitamin B3, Vitamin C, garlic extract, and turmeric.
